(19) United States
(12) Patent Application Publication
(10) Pub. No.: US 2023/0131828 A1
(43) Pub. Date: Apr. 27, 2023

(54) PREDICTIVE MAINTENANCE SYSTEM AND METHOD FOR INTELLIGENT MANUFACTURING EQUIPMENT

(71) Applicant: CHINA ELECTRONICS RELIABILITY AND ENVIRONMENTAL TESTING INSTITUTE ((THE FIFTH INSTITUTE OF ELECTRONI, Guangzhou (CN)

(72) Inventors: Yuanhang WANG, Guangzhou (CN); Chunhui WANG, Guangzhou (CN); Jian ZHOU, Guangzhou (CN); Xiaojian DING, Guangzhou (CN); Wenwei LIU, Guangzhou (CN); Zhong SHI, Guangzhou (CN); Chao LIANG, Guangzhou (CN); Chengju DONG, Guangzhou (CN); Bochen CHEN, Guangzhou (CN); Chuangmian HUANG, Guangzhou (CN); Jianfeng YANG, Guangzhou (CN); Jing TANG, Guangzhou (CN); Ji WANG, Guangzhou (CN); Xiaobing LI, Guangzhou (CN); Shuhan LU, Guangzhou (CN); Wenan MO, Guangzhou (CN); Yunfan YANG, Guangzhou (CN); Guangkuo GUO, Guangzhou (CN)

(73) Assignee: CHINA ELECTRONICS RELIABILITY AND ENVIRONMENTAL TESTING INSTITUTE ((THE FIFTH INSTITUTE OF ELECTRONI, Guangzhou (CN)

(21) Appl. No.: 17/863,374

(22) Filed: Jul. 12, 2022

(30) Foreign Application Priority Data
Oct. 20, 2021 (CN) 202111218250.9

(51) Int. Cl. G05B 23/02

(52) U.S. Cl. CPC G05B 23/0283; G05B 23/0221; G05B 23/0243; G05B 23/0281

(57) ABSTRACT

A predictive maintenance system and method for intelligent manufacturing equipment is provided. The predictive maintenance system includes a first-stage predictive maintenance module, a second-stage predictive maintenance module, and a maintenance decision module. The first-stage predictive maintenance module includes an acquisition module, a human-computer interaction module, a calculation module, and a storage module. The second-stage predictive maintenance module includes a communication module, a setting module, and a prediction module. The maintenance decision module is configured to receive a first-stage remaining service life calculated by the first-stage predictive maintenance module and a second-stage remaining service life predicted by the second-stage predictive maintenance module, and determine a predictive maintenance strategy of the intelligent manufacturing equipment according to the first-stage remaining service life and the second-stage remaining service life. The present disclosure may reduce unexpected shutdown, reduce the costs of operation and maintenance, and improve the efficiency of operation and maintenance.

### RELATED APPLICATIONS

This application claims the benefit of priority of Chinese patent application No. 202111218250.9, filed Oct. 20, 2021, and the content of which is incorporated herein by reference in its entirety.

### TECHNICAL FIELD

The present disclosure relates to the technical field of intelligent manufacturing, and in particular, to a predictive maintenance system and method for intelligent manufacturing equipment.

### BACKGROUND

In recent years, manual jobs with high risk, high intensity and repetitiveness characteristics are gradually taken by machines. With the transformation and upgrading of manufacturing automation, digitalization and intelligence, intelligent manufacturing equipment, represented by industrial robots, has become more important in the modern manufacturing industry. However, equipment failures are inevitable, and intelligent manufacturing equipment is prone to degradation and damage under long-term, repetitive work. Due to the unmanned and automated scenario of intelligent manufacturing, intelligent manufacturing equipment and systems require repair and maintenance to maximize the efficiency of intelligent manufacturing.

The common practice at present is to repair the equipment only after the product quality of the process has gone wrong (i.e., the rate of defective products has increased) or even after the equipment has been shut down, which is known as post-failure repair (repair after failure), resulting in unexpected shutdown. Alternatively, regular maintenance, i.e., replacement at a specified time, may result in early replacement of many components that can still be used, which is wasteful, while many frequently used components cannot last till the specified replacing time, resulting in an unexpected failure. When an unexpected failure occurs, an equipment user needs to notify the manufacturer or integrator to diagnose and repair the failure on site, which wastes the time and cost of the equipment or even the entire automated production line, and does not meet the requirements of modern manufacturing. Therefore, it is necessary to provide proactive predictive maintenance solutions for equipment, to provide technical support for proactive operation and maintenance of the equipment, reduce unexpected shutdown, and reduce production costs.

### BRIEF SUMMARY

An objective of the present disclosure is to provide a predictive maintenance system and method for intelligent manufacturing equipment, which can provide technical support for proactive operation and maintenance of the intelligent manufacturing equipment, reduce unexpected shutdown, reduce the costs of operation and maintenance, and improve the efficiency of operation and maintenance.

To achieve the foregoing objective, an aspect of the present disclosure provides a predictive maintenance system for intelligent manufacturing equipment, including a first-stage predictive maintenance module, a second-stage predictive maintenance module, and a maintenance decision module. The first-stage predictive maintenance module includes an acquisition module, a human-computer interaction module, a calculation module, and a storage module. The acquisition module is configured to obtain control parameters of the intelligent manufacturing equipment; the human-computer interaction module is configured to trigger the calculation module to perform calculation; the storage module is configured to save the control parameters acquired by the acquisition module; the calculation module is configured to calculate a first-stage remaining service life of the intelligent manufacturing equipment based on a statistical model or an empirical model according to the control parameters saved by the storage module. The second-stage predictive maintenance module includes a communication module, a setting module, and a prediction module. The communication module is configured to receive state parameters and spot check parameters of the intelligent manufacturing equipment; the setting module is configured to set a degradation threshold and a failure threshold for each state parameter and each spot check parameter; the prediction module is configured to construct a time series starting from the degradation threshold for each state parameter or spot check parameter that exceeds the degradation threshold, perform degradation modeling for the constructed multiple time series, and predict a second-stage remaining service life of the intelligent manufacturing equipment. The maintenance decision module is configured to receive a calculation result of the first-stage predictive maintenance module and a prediction result of the second-stage predictive maintenance module, and determine a predictive maintenance strategy of the intelligent manufacturing equipment according to the first-stage remaining service life and the second-stage remaining service life.

Another aspect of the present disclosure provides a predictive maintenance method for intelligent manufacturing equipment, including: obtaining control parameters and state parameters of the intelligent manufacturing equipment in real time, and obtaining spot check parameters of the intelligent manufacturing equipment periodically; triggering first-stage predictive maintenance, and in the first-stage predictive maintenance, calculating a first-stage remaining service life of the intelligent manufacturing equipment based on a statistical model or an empirical model according to the control parameters; stopping the first-stage predictive maintenance and triggering second-stage predictive maintenance when any one of the state parameters and the spot check parameters exceeds a preset degradation threshold; in the second-stage predictive maintenance, constructing at least one time series starting from the degradation threshold for each state parameter or spot check parameter exceeding the degradation threshold, performing degradation modeling for the at least one time series, and predicting a second-stage remaining service life of the intelligent manufacturing equipment; and determining a predictive maintenance strategy of the intelligent manufacturing equipment according to the first-stage remaining service life and the second-stage remaining service life.

The predictive maintenance system and method for intelligent manufacturing equipment of the present disclosure can effectively predict a service life of the intelligent manufacturing equipment, and determine a predictive maintenance strategy according to the predicted remaining service life, thereby reducing unexpected shutdown, shortening downtime, reducing the costs of operation and maintenance, and improving the efficiency of operation and maintenance.

### BRIEF DESCRIPTION OF THE DRAWINGS

FIG. 1 is a schematic structural diagram of intelligent manufacturing equipment according to some exemplary embodiments of the present disclosure;

FIG. 2 is a schematic composition diagram of a predictive maintenance system for intelligent manufacturing equipment according to some exemplary embodiments of the present disclosure;

FIG. 3 is a schematic operation diagram of a first-stage predictive maintenance module according to some exemplary embodiments of the present disclosure;

FIG. 4 is a schematic operation diagram of a second-stage predictive maintenance module according to some exemplary embodiments of the present disclosure;

FIG. 5 is a flowchart of a predictive maintenance method for intelligent manufacturing equipment according to some exemplary embodiments of the present disclosure;

FIG. 6 is a schematic diagram of a prediction mechanism of second-stage service life prediction according to some exemplary embodiments of the present disclosure; and

FIG. 7 is a schematic structural diagram of a predictive maintenance system for intelligent manufacturing equipment according to some exemplary embodiments of the present disclosure.

### DETAILED DESCRIPTION

To enable those skilled in the art to better understand the technical solutions of the present disclosure, some specific exemplary embodiments of the present disclosure will be further described in detail below with reference to the accompanying drawings.

The present disclosure provides a predictive maintenance system and method for intelligent manufacturing equipment, which may be applied to predictive maintenance of typical reciprocating mechanical equipment such as industrial robots in an intelligent manufacturing environment, and may effectively predict a service life of the intelligent manufacturing equipment and make maintenance plans based on the predicted remaining service life.

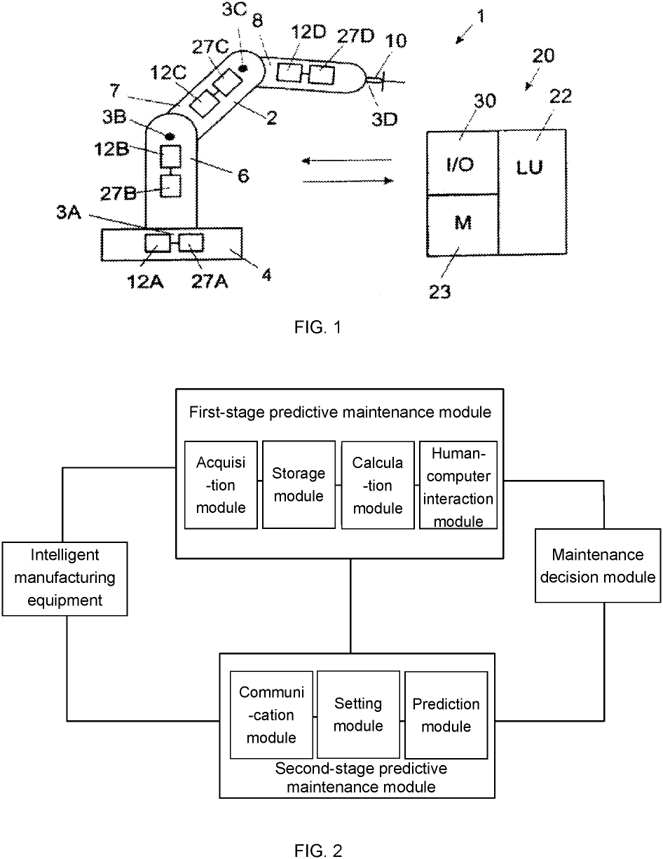

In order to facilitate the understanding of the technical solutions of the exemplary embodiments of the present disclosure, the main components and principles of the intelligent manufacturing equipment are first introduced. FIG. 1 is a schematic structural diagram of intelligent manufacturing equipment according to some exemplary embodiments of the present disclosure. Taking an industrial robot as an example, as shown in FIG. 1, an industrial robot 1 may include a body 2 and a control system 20. The body 2 may include a plurality of connecting rods (shafts) that move with each other, such as a base 4, first to third arms 6 to 8, and a wrist 10. The connecting rods from the base 4 upward may be referred to as a first shaft, a second shaft, and so on. 4-shaft and 6-shaft robots are commonly seen robots. Rotatable (movable) portions between the connecting rods are referred to as “joints”, such as first to fourth joints 3A, 3B, 3C, and 3D. The motion of each joint is driven by first to fourth servo motors 12A, 12B, 12C, and 12D, and each servo motor is connected to a reducer for precise deceleration (the reducer is not shown in the figures). The control system 20 may include a logic control unit 22, a memory unit 23, an input/output (IO) interface 30, and first to fourth drive units (or servo drivers) 27A, 27B, 27C, 27D. The logic control unit 22 may be a microprocessor that generates motion trajectories according to a control program. Each servo driver controls a current and a position of each servo motor according to a signal from the logic control unit 22, to achieve a desired motion.

In an intelligent manufacturing environment, intelligent manufacturing equipment such as industrial robots often performs repetitive work. Especially, in process-oriented manufacturing (for most automated production lines), the working condition is relatively fixed, or the manufacturing switches among several working conditions (when the beat of the production line changes, the working condition is switched). In the case of discrete manufacturing industries, such as computer numerical control (CNC) machine tools, the working condition may be more complex and variable. In this case, the working condition may be divided into multiple short working conditions. The predictive maintenance system and method of the present disclosure may be applicable to predictive maintenance of the intelligent manufacturing equipment under both fixed and variable working conditions.

FIG. 2 is a schematic composition diagram of a predictive maintenance system for intelligent manufacturing equipment according to some exemplary embodiments of the present disclosure. As shown in FIG. 2, the predictive maintenance system for intelligent manufacturing equipment according to some exemplary embodiments of the present disclosure may include a first-stage predictive maintenance module, a second-stage predictive maintenance module, and a maintenance decision module.

The first-stage predictive maintenance module may be an embedded module which is integrated in a control system of the intelligent manufacturing equipment, or may be an independent hardware apparatus which interacts with the control system of the intelligent manufacturing equipment via a bus/network cable. The first-stage predictive maintenance module may include an acquisition module, a human-computer interaction module, a calculation module, and a storage module.

The acquisition module may be configured to acquire control parameters of the intelligent manufacturing equipment. The control parameters herein are parameters used for precise motion control of intelligent manufacturing equipment such as industrial robots, which may be correlated with working conditions, and therefore are also referred to as working condition parameters. The weak parts of the intelligent manufacturing equipment may include mechanical components, electrical components, hydraulic components, etc. A remaining service life of the intelligent manufacturing equipment may depend on the remaining service lives of these weak parts. In the case of mechanical components, the control parameters include speed, torque, etc.; in the case of electrical components, the control parameters include current, voltage, etc.; in the case of hydraulic components, the control parameters include pressure, flow rate, etc. The acquisition module may set a flag bit M, where M=0 initially. For a discrete scenario with variable working conditions, M is always 0, and data needs to be continuously acquired and saved in real time. In a process-based scenario with a constant working condition, the flag bit M may be set to 1 when acquisition lasts specified acquisition cycles (e.g., 20 cycles), and acquisition is stopped; M is reset to 0 when the working condition is switched, and new data is acquired and saved without overwriting the acquired data corresponding to the previous working condition.

The human-computer interaction module is configured to trigger the calculation module to perform calculation, and may support three trigger modes: triggering manually by a user of the intelligent manufacturing equipment, triggering according to a preset work cycle, and triggering when a working condition changes. The human-computer interaction module may be further configured to display a calculation result of the calculation module and upload the calculation result to cloud.

The storage module may be configured to save the control parameters acquired by the acquisition module. If the first-stage predictive maintenance module is integrated in the control system of the intelligent manufacturing equipment, considering the limitations of the storage capacity and computing resources of the control system, the storage module may only store parameters acquired by the acquisition module after a last trigger.

The calculation module may be configured to calculate a first-stage remaining service life of the intelligent manufacturing equipment based on a statistical model or an empirical model according to the control parameters saved by the storage module.

FIG. 7 illustrates an exemplary structure of the predictive maintenance system for intelligent manufacturing equipment. The system includes at least one processor, at least one storage medium, an input/output (I/O) device, a communication port, and the like. It is noted that each module described above or below in the present application may be a hardware element, or a set of instructions stored in a storage medium as a separate storage medium in the system or a storage medium integrated with a component of the system, or a combination of a hardware part and an instruction part. The predictive maintenance method for intelligent manufacturing equipment described later in the present disclosure may be implemented with the predictive maintenance system including the foregoing components. As described above, the predictive maintenance system according to some exemplary embodiments of the present disclosure may include at least one storage medium storing a set of instructions for implementing the predictive maintenance method provided by the present disclosure; and at least one processor in communication with the at least one storage medium; during operation, the at least one processor executes the set of instructions via the first-stage predictive maintenance module, for example, to obtain control parameters of the intelligent manufacturing equipment, calculate a first-stage remaining service life of the intelligent manufacturing equipment based on a statistical model or an empirical model according to the control parameters, and so on; the at least one processor executes the set of instructions via the second-stage predictive maintenance module, for example, to receive state parameters and spot check parameters of the intelligent manufacturing equipment, set a degradation threshold and a failure threshold for each state parameter and each spot check parameter, and so on; the at least one processor executes the set of instructions via the maintenance decision module, for example, to receive a calculation result of the first-stage predictive maintenance module and a prediction result of the second-stage predictive maintenance module, and determine a predictive maintenance strategy of the intelligent manufacturing equipment according to the first-stage remaining service life and the second-stage remaining service life, etc.

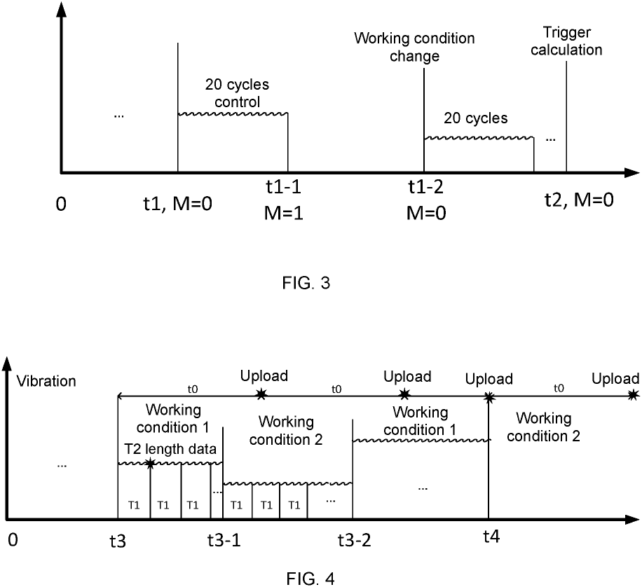

FIG. 3 is a schematic diagram of operation of a first-stage predictive maintenance module according to some exemplary embodiments of the present disclosure. As shown in FIG. 3, the calculation module may output a first-stage remaining service life I1 at moment t1, and resets M=0. The acquisition module acquires control information, and by moment t1-1, all data of the specified cycles (e.g., 20 cycles) may be acquired, and M is then set to 1. At moment t1-2, the beat of the production line changes, that is, the working condition changes, M is reset to 0, and acquisition lasts 20 cycles. The process is repeated in this way until moment t2 when the specified work cycle is reached or the user manually triggers, through a human-computer interaction interface of the human-computer interaction module, the calculation module to perform calculation. The calculation module reads the time information, such as t1, t1-1, and t1-2, saved by the storage module and the “working condition-control” information packet cumulatively acquired by the acquisition module to perform calculation, and outputs a first-stage remaining service life I2 at the moment t2 (the specific calculation method will be provided below). The human-computer interaction module displays the result, uploads the result to the cloud, and resets M to 0, to start a new round of acquisition and calculation.

The second-stage predictive maintenance module may operate on the cloud, and may include a communication module, a setting module, and a prediction module. The communication module may be configured to receive state parameters and spot check parameters of the intelligent manufacturing equipment. Specifically, the second-stage predictive maintenance module may receive two types of data from the field side of the intelligent manufacturing equipment via the communication module. One type of data is state data acquired by the intelligent manufacturing equipment itself (with the advancement of intelligent manufacturing and intelligent services, many high-end industrial robots are equipped with sensors at joints and parts, such as temperature and vibration sensors, for monitoring “state parameters”), which is communicated according to a preset communication cycle. In other words, the cloud may send a data request to the field side at intervals of the communication cycle, and the field side may package all the “working condition-state” information in this period of time and uploads the information packet. The other type of data is “spot check information” in the spot check/inspection process of the equipment. The intelligent manufacturing equipment periodically carries out a “physical” test of a specific working condition. For example, if an industrial robot operates according to a predetermined specific working condition (e.g. standard production line working condition or single-shaft independent working condition), the spot check parameters (state parameters of the specific working condition) of the operating process may be acquired. The spot check parameters can be sent in response to a communication request from the field side to the cloud, and the data may be uploaded to the cloud after the spot check test. The state parameters and spot check parameters may include, but are not limited to, processing quality, control deviation, temperature rise, vibration acceleration characteristic quantity, electrical signal characteristic parameter, etc.

In some exemplary embodiments, in the case where the first-stage predictive maintenance module is embedded in the control system of the intelligent manufacturing equipment, parameters required by the second-stage predictive maintenance module may also be obtained from the first-stage predictive maintenance module; in the case where the first-stage predictive maintenance module is an independent hardware apparatus (not embedded in the control system) that operates separately, the acquisition module of the first-stage predictive maintenance module may obtain related parameters from the control system of the intelligent manufacturing equipment, and then transmit the parameters to the second-stage predictive maintenance module.

The second-stage predictive maintenance may adopt a dual-threshold mechanism, including a threshold A and a threshold B, where the former is referred to as a degradation threshold; and the latter is referred to as a failure threshold. When the received state parameter or spot check parameter exceeds the threshold A of a parameter, the prediction module may be triggered. That is, when the equipment is normal, no prediction is needed. However, when a key indicator (a parameter) exceeds its specified threshold A, it is a warning of a possible abnormality, and thus the parameter needs to be tracked continuously. Then, a time point when the parameter may reach its failure threshold B may be predicted, and the time period it may take to reach the failure threshold B is the remaining service life.

In the foregoing mechanism, the setting module may be configured to set a degradation threshold A and a failure threshold B for each parameter respectively. The setting module may also set different acquisition cycles and communication cycles for different parameters in normal (not exceeding the degradation threshold) and abnormal (exceeding the degradation threshold) states. That is, in the normal state, data may be transmitted slowly (e.g., 10 acquisitions nd one packet transmission per day), and after an out-of-tolerance abnormality occurs, data needs to be transmitted faster (e.g., one acquisition per minute, and one transmission every 10 minutes). The frequency depends on the failure and signal characteristics as well as the resource consumption needed. The communication module may receive, based on the communication cycle from the intelligent manufacturing equipment, the state parameters and the spot check parameters acquired based on the acquisition cycle. The setting module may be further configured to: after the abnormal state has occurred, if state data acquired in several consecutive acquisitions (e.g. 5 acquisitions) or spot check data in the next acquisition does not exceed the respective criteria, identify the abnormality as an environmental disturbance or a system error, and recover the communication cycle in the normal state.

The prediction module may be configured to construct a time series starting from the degradation threshold for each state parameter or each spot check parameter that exceeds the degradation threshold, perform degradation modeling for the constructed multiple time series, and predict a second-stage remaining service life of the intelligent manufacturing equipment. Specifically, after being triggered, the prediction module may construct, for the state parameter or spot check parameter that exceeds the degradation threshold A (hereinafter also referred to as an out-of-tolerance parameter), a time series of historical data that exceeds the threshold. For the spot check parameter, the time series may be constructed separately, and for the state parameter, the time series may be constructed according to the working condition, to form a spot check series of the same parameter and state series under different working conditions. A data-driven approach may be employed to fit the multiple series. Models may be obtained by fitting the multiple series, to calculate the remaining service lives respectively. Statistical data of the remaining lives may be collected by selecting a suitable distribution, such as a normal distribution, to obtain a remaining service life distribution.

FIG. 4 is a schematic operation diagram of a second-stage predictive maintenance module according to some exemplary embodiments of the present disclosure. As a typical representative of intelligent manufacturing equipment, an industrial robot may have motor-driven joints. However, it is noted that motor and reducer failures often occur, with different failure characteristics. For example, mechanical failures may be characterized by vibrations, and electrical failures may be characterized by currents. Therefore, some advanced robots may monitor vibration accelerations or motor currents at critical locations. Taking the vibration acceleration as an example, if there are three points A, B and C in the working space of an industrial robot, working condition 1 is 100% load and 100% speed from A to B, and working condition 2 is 50% load and 50% speed from A to C. The operation is shown in FIG. 4: working condition 1 applies to t3 to t3-1, working condition switching is performed at t3-1, working condition 2 applies to t3-1 to t3-2, working condition switching is then performed at t3-2, working condition 1 applies to t3-2 to t4, and spot check is performed at t4.

For example, for a vibration acceleration signal at a certain location, it is necessary to pay attention to its intensity characteristic quantity. The intensity characteristic quantity may be calculated at an interval of T1 after t3, and raw data of the last T2 length may be be stored and communicated according to the communication cycle t0. In other words, the cloud may send a data request to the field side at an interval of t0, and the field side packages all the “working condition-state” information within this time interval and then uploads the information. The cloud receives the packaged data once, spot check is then performed at moment t4, all spot check data is uploaded, and then T1 and t0 are calculated again. The process is repeated in this way. When the intensity detected at a certain moment exceeds a specified intensity threshold A:
(1) A flag bit f2 is set to 1, the second-stage predictive maintenance module is started, and the first-stage predictive maintenance module is suspended.
(2) The second-stage predictive maintenance module is started. Intensities under working condition 1, working condition 2, and spot check are classified first, and time series are constructed for intensity data of different categories, which may include an intensity time series 1 under working condition 1, an intensity time series under working condition 2, and an intensity time series 0 under spot check. The intensity time series 1, 2, and 3 may be fitted separately based on a data-driven approach, to predict remaining service lives L1, L2, and L0. Working condition ratios may be obtained by dividing time lengths corresponding to working condition 1 and by a total time. The ratios may be used as weights w1 and wof the service lives L1 and L2, where L1*w1+L2*wmay be used as a predicted working condition service life, and L0 may be used as a standard service life. A weighted variance of the remaining service lives L1 and Land the standard service life L0 may be calculated so as to obtain a service life distribution (such as a normal distribution).
(3) The setting module shortens the T1 and t0, such that the acquisition and transmission may be performed more frequently.

The maintenance decision module may be configured to receive a calculation result of the first-stage predictive maintenance module and a prediction result of the second-stage predictive maintenance module, and determine a predictive maintenance strategy of the intelligent manufacturing equipment according to the first-stage remaining service life and the second-stage remaining service life. The maintenance decision module may operate at a mobile terminal such as a mobile computer or a mobile phone, or may operate at a field side of the intelligent manufacturing equipment, and receive service life prediction results of the first-stage predictive maintenance and the second-stage predictive maintenance, or query historical prediction result records. Spare parts of the intelligent manufacturing equipment may be purchased with reference to the service life result of the first-stage prediction, and an optimal maintenance solution may be determined with reference to the service life result of the second-stage prediction in combination with a production plan, including maintenance time, maintenance resources, and maintenance measures.

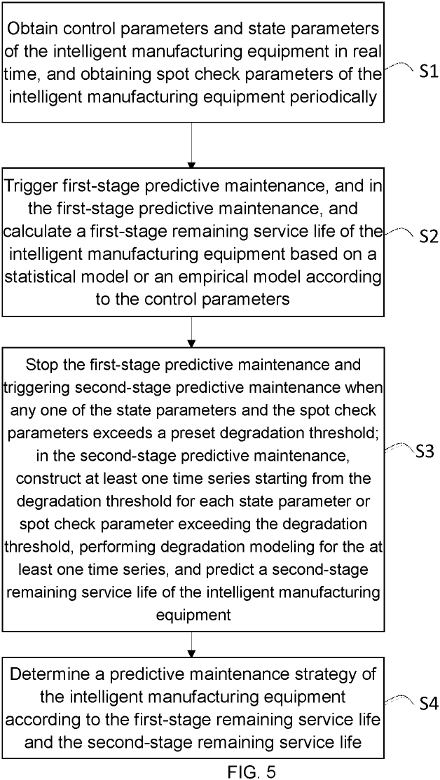

Some exemplary embodiments of the present disclosure further provide a predictive maintenance method for intelligent manufacturing equipment. FIG. 5 is a flowchart of a predictive maintenance method for intelligent manufacturing equipment according to some exemplary embodiments of the present disclosure. The predictive maintenance method according to some exemplary embodiments of the present disclosure may be implemented by the predictive maintenance system for intelligent manufacturing equipment described in some exemplary embodiments of the present disclosure, or implemented by other systems, provided that the process of the predictive maintenance method according to some exemplary embodiments may be implemented.

As shown in FIG. 5, the predictive maintenance method includes steps S1 to S4. In step S1, control parameters and state parameters of the intelligent manufacturing equipment are acquired in real time, and spot check parameters are acquired periodically. Step S1 may be implemented by online monitoring. The online monitoring may include: (1) real-time acquisition and monitoring of working condition parameters, where the working condition parameters mainly include a rotational speed and a torque; (2) online monitoring of state parameters, where the state parameters include characteristic quantities related to failure and service life, including signal characteristic quantities such as machining quality, control deviation, electrical signal, vibration, temperature, and pressure; (3) periodic acquisition of the spot check parameters, where the spot check parameters are state parameters under a specific test working condition.

In step S2, first-stage predictive maintenance is triggered; in the first-stage predictive maintenance, a first-stage remaining service life of the intelligent manufacturing equipment is calculated based on a statistical model or an empirical model according to the control parameters. In step S3, when any one of the state parameters and the spot check parameters exceeds a preset degradation threshold, the first-stage predictive maintenance is stopped, and second-stage predictive maintenance is triggered; in the second-stage predictive maintenance, a time series starting from the degradation threshold is constructed for each state parameter or spot check parameter that exceeds the degradation threshold, degradation modeling is performed for the constructed multiple time series, and a second-stage remaining service life of the intelligent manufacturing equipment is predicted.

The predictive maintenance method in some exemplary embodiments of the present disclosure may include a two-stage predictive maintenance mechanism. The first-stage predictive maintenance may be carried out once the intelligent manufacturing equipment is installed on the floor, and the working condition parameters are acquired in real time. The first-stage remaining service life may be calculated based on an empirical formula with the working condition parameters. In the second-stage predictive maintenance, double thresholds: degradation threshold A and failure threshold B, may be provided for each state parameter and each spot check parameter. When any one of the foregoing parameters exceeds its threshold A, the second-stage service life prediction (second-stage predictive maintenance) may be triggered to predict the second-stage remaining service life during which the degradation threshold A develops to the failure threshold B. After the second-stage service life prediction is triggered, the first-stage predictive maintenance is suspended. The principle is as follows: the first-stage predictive maintenance mainly calculates the number of repetitions of the equipment according to statistical data or the empirical formula, which belongs to long-term empirical prediction; the second-stage predictive maintenance performs real-time and short-term prediction according to the actually acquired data. The second-stage predictive maintenance better reflects individual service life differences of various equipment. The priority of the second-stage predictive maintenance is higher than that of the first-stage predictive maintenance. When an abnormality occurs (the parameter exceeds the degradation threshold A), the second-stage predictive maintenance may be triggered, and the first-stage predictive maintenance may be suspended.

In the first-stage predictive maintenance, the working condition parameters may be acquired in real time since the beginning of the whole service life cycle of the equipment. In the case of a fixed working condition, working condition parameters in a certain number of cycles may be acquired, and then the number of cycles is counted. In the case of a variable working condition, parameters in a certain number of cycles need to be acquired again, and the process is repeated in this way. In step S2, in some exemplary embodiments, the triggering of the first-stage predictive maintenance may include three modes: triggering manually by a user of the intelligent manufacturing equipment, triggering according to a preset work cycle, and triggering when a working condition changes. Moreover, in some exemplary embodiments, after the first-stage predictive maintenance is triggered, equivalent loads under different working conditions may be calculated according to working condition parameters acquired within a time interval between a current moment and a last trigger moment, a degree of loss at the current moment may be calculated according to the obtained equivalent loads, and then the first-stage remaining service life may be calculated according to the degree of loss at the current moment.

The intelligent manufacturing equipment may have certain multiple weak parts. In some exemplary embodiments, in the first-stage predictive maintenance of step S2, when multiple acting forces are applied to a certain component of the intelligent manufacturing equipment, respective degrees of loss under the acting forces may be calculated, then the degrees of loss under the acting forces may be superimposed linearly, a remaining service life of the component may be then calculated according to the superimposed degrees of loss, and a minimum value of remaining service lives of all components may be taken as the first-stage remaining service life of the intelligent manufacturing equipment.

In some exemplary embodiments, if a weak part of the intelligent manufacturing equipment is a mechanical component (such as a reducer or a motor), the acting forces may include a torque and a radial force, and in the first-stage predictive maintenance, a torque service life of the mechanical component under the torque is calculated; a radial force service life of the mechanical component under the radial force may be calculated; degrees of loss under the torque and the radial force may be superimposed linearly, where the degree of loss under the torque or the radial force is equal to a ratio of a time length between the current trigger moment and the last trigger moment to a torque service life or a radial force service life corresponding to a working condition within the time length; and a remaining service life of the mechanical component may be calculated according to the superimposed degrees of loss. Further, in the case of multiple torques and multiple radial forces, degrees of loss of the multiple torques or the multiple radial forces may be superimposed linearly, and then the first-stage remaining service life may be calculated according to the superimposed degrees of loss.

The following specifically describes the calculation method of the first-stage remaining service life in the case where the weak part of the intelligent manufacturing equipment is a mechanical component (such as a reducer or a motor).

(1) The mechanical component is only under a torque:

An equivalent rotation speed nₘ₁ and an equivalent torque Tₘ₁ within a time period 0-t₁ are calculated based on equation (1) according to a working condition curve from 0 to the first trigger moment (which is assumed to be t₁ in FIG. 3).

$$\left\{\begin{matrix}{n}_{m} = \sum \left({t}_{i} {n}_{i}\right) / \sum \left({t}_{i}\right) = {\int }_{0}^{{T}_{0}} n \text{d} t / {\int }_{0}^{{T}_{0}} \text{d} t \\ {T}_{\text{m}} = {\left[\sum \left({t}_{i} {n}_{i} {T}_{i}^{e}\right) / \sum \left({t}_{i} {n}_{i}\right)\right]}^{1 / e} = {\left[{\int }_{0}^{{T}_{0}} \left({n}_{i} {T}_{i}^{e}\right) d t / {\int }_{0}^{{T}_{0}} {n}_{i} \text{d} t\right]}^{1 / e}\end{matrix}\right)$$

nₘ₁ and Tₘ₁ are substituted into equation (2) to calculate a service life τ_{m₁} at moment t₁, indicating that an operable service life is τₘ₁ based on the working condition from 0 to moment t₁.

$${τ}_{m} = {τ}_{0} {n}_{0} {T}_{0}^{e} / \left({n}_{m} {T}_{m}^{e}\right) = {τ}_{0} {n}_{0} {T}_{0}^{e} \sum {t}_{i} / \sum \left({t}_{i} {n}_{i} {T}_{i}^{e}\right)$$

In the two equations above, t_{m:} service life;
τ₀ : design service life in hours (h) at rated torque;
n₀: output rated speed in revolutions per minute (r/min);
tᵢ: moment within time period 0-t₁;
Tᵢ: output torque in Newton meters (N·m) at moment tᵢ;
nᵢ: output rotation speed in revolutions per minute (r/min) at moment tᵢ;
T₀: output rated torque in Newton meters (N·m);
nₘ: output average rotation speed in revolutions per minute (r/min),
$${n}_{m} = \sum \left({t}_{i} {n}_{i}\right) / \sum {t}_{i} ;$$
Tₘ: output average load torque in Newton meters (N·m);
e: service life index. It is recommended that e=10/3 or e=3.

The degree of loss at moment t₁ is: r₁ = t₁ / τₘ₁ x 100%.

The remaining service life at moment t₁ is:

$${τ}_{1} = {τ}_{m 1} - {t}_{1} = \left(1 - {r}_{1}\right) ∗ {τ}_{m 1} .$$

Similarly, at moment tₓ (x is a positive integer no less than 2), the first-stage service life prediction function is triggered (because calculation has been performed at tₓ₋₁, calculation at tₓ is carried out based on the calculation at tₓ₋₁). The calculation process is as follows:

An equivalent rotation speed nₘₓ and an equivalent torque Tₘₓ from tₓ₋₁ to tₓ are calculated according to equation (1).

nₘₓ and Tₘₓ are substituted into equation (2) to calculate a service life τₘₓ at moment tₓ, indicating that an operable service life is τₘₓ based on the working condition from tₓ₋₁ to moment tₓ.

The degree of loss at moment t_{X} is:

$${r}_{x} = \left[{r}_{x - 1} + \frac{{t}_{x} - {t}_{x - 1}}{{τ}_{m x}}\right] \times 100 \% ,$$

where t₀=0.

The remaining service life at moment tₓ is: τₓ = (1-rₓ) × τₘₓ.

(2) The mechanical component is subject to not only the torque but also a radial force. The mechanical component is, for example, a reducer or a motor driven by a belt at a joint of an industrial robot, and the bearing is one of the important weak parts:

A fatigue service life under the radial force can be calculated as follows:

$${ϕ}_{m} = \frac{{10}^{6}}{60 {n}_{m}} {\left(\frac{{C}_{0}}{{F}_{r}}\right)}^{e}$$

C₀: rated dynamic load (N), which may be found in a bearing product manual (or machinery manual or national standard).

Fᵣ: value of the radial force of the bearing, which can be calculated according to a preload force of the belt drive and a distance between the bearing and a force acting point of the belt drive.

As can be seen, the model has a linear relationship.

At moment tₓ, the calculation process is as follows:

An equivalent rotation speed nₘₓ and an equivalent torque Tₘₓ from tₓ₋₁ to tₓ are calculated according to equation (1).

nₘₓ and Tₘₓ are substituted into equation (2), and a “torque” service life τₘₓ at moment tₓ is calculated.

nₘₓ is substituted into equation (3), and a “radial force” service life ϕₘₓ at moment tₓ is calculated.

The degree of loss at moment tₓ is:

$${r}_{x} = \left[{r}_{x - 1} + \frac{{t}_{x} - {t}_{x - 1}}{{τ}_{m x}} + \frac{{t}_{x} - {t}_{x - 1}}{{ϕ}_{m x}}\right] * 100 \% , w h e r e {t}_{0} = 0.$$

The remaining service life at moment tₓ is:

$${τ}_{x} = \frac{1 - {r}_{x}}{1 / {τ}_{m x} + 1 / {ϕ}_{m x}} .$$

By comparing degree-of-loss equations (1) under the torque only and (2) under the torque+radial force, it may be learned that: (1) under the torque only, the degree of loss rₓ at moment tₓ is the degree of loss rₓ₋₁ of the previous moment plus a new loss amount, that is, a time length (tₓ-tₓ₋₁) divided by the torque service life τₘₓ corresponding to the working condition within the time length; (2) under the torque+radial force, based on the degree of loss under (1), a degree of loss under the radial force is added, that is, the time length divided by the radial force service life ϕₘₓ corresponding to the working condition within the time length. Therefore, under the torque+radial force, the concept of “damage accumulation” is adopted.

(3) If there are multiple torques or multiple radial forces, the calculation may be further carried out according to the above concept of “damage accumulation”. That is, the degrees of loss of the multiple torques or multiple radial forces are linearly added up, and the degree of loss of each torque or radial force is equal to a ratio of a time length between the current trigger moment and the last trigger moment to a torque service life or a radial force service life corresponding to a working condition within the time length.

(4) If there is more than one weak part, after the remaining service life of each weak part is calculated, a minimum remaining service life is taken as the remaining service life of a higher-level part.

For example, an industrial robot has 6 joints, and each joint is provided with a motor and a reducer. A motor has two bearings; a reducer has multiple bearings, a shortest service lives of the bearings in the motor may be taken as the service life of the motor; a shortest service life of the motor and the service life of the reducer in the joint may be taken as the service life of the joint; a shortest service life of a joint among the 6 joints may be taken as the service life of the industrial robot, and so on.

For the predictive maintenance method for intelligent manufacturing equipment according to some exemplary embodiments of the present disclosure, in step S3, when any one of the state parameters and the spot check parameters exceeds a preset degradation threshold, the first-stage predictive maintenance is stopped, and second-stage predictive maintenance is triggered; in the second-stage predictive maintenance, a time series starting from the degradation threshold may be constructed for each state parameter or spot check parameter that exceeds the degradation threshold, degradation modeling may be performed for the constructed multiple time series, and a second-stage remaining service life of the intelligent manufacturing equipment is thus predicted.

In the second-stage predictive maintenance, in some exemplary embodiments, degradation modeling is respectively performed for the constructed multiple time series to predict remaining service lives under different working conditions, and statistical data regarding the remaining service lives may be collected based on a normal distribution, to obtain a remaining service life distribution as the second-stage remaining service life. Moreover, in the second-stage predictive maintenance, the performing of the degradation modeling for the constructed multiple time series may include: performing piecewise fitting on the time series under different working conditions; selecting a Wiener process to obtain degradation rates and degradation uncertainty under different working conditions; and predicting remaining service lives under the different working conditions based on models corresponding to the degradation rates and the degradation uncertainty under the different working conditions.

Specifically, the second-stage service life prediction may be a data-driven modeling prediction method. The fitting prediction may be performed according to historical curves of out-of-tolerance parameters. The out-of-tolerance parameters under working condition 1, working condition 2, and spot check may be classified first, and time series may be constructed for data of different categories, which are an intensity time series 1 under working condition 1, an intensity time series 2 under working condition 2, and an intensity time series 0 under spot check. These time series may be fitted separately based on a data-driven approach, to predict remaining lives L1, L2, and L0 under different working conditions. Working condition ratios may be obtained by dividing time lengths corresponding to working condition 1 and 2 by a total time. The ratios may be used as weights w1 and w2 of the remaining lives L1 and L2, where L1*w1+L2*w2 is used as a predicted average working condition service life, and L0 is used as a standard service life. A weighted variance of the remaining lives L1 and L2 and the standard service life L0 may be calculated to obtain a service life distribution (such as a normal distribution). If the spot check is omitted or the number of spot checks is insufficient, feasible L0 cannot be obtained. In this case, the weighted mean and variance of L1 and L2 may be used directly to obtain the service life distribution.

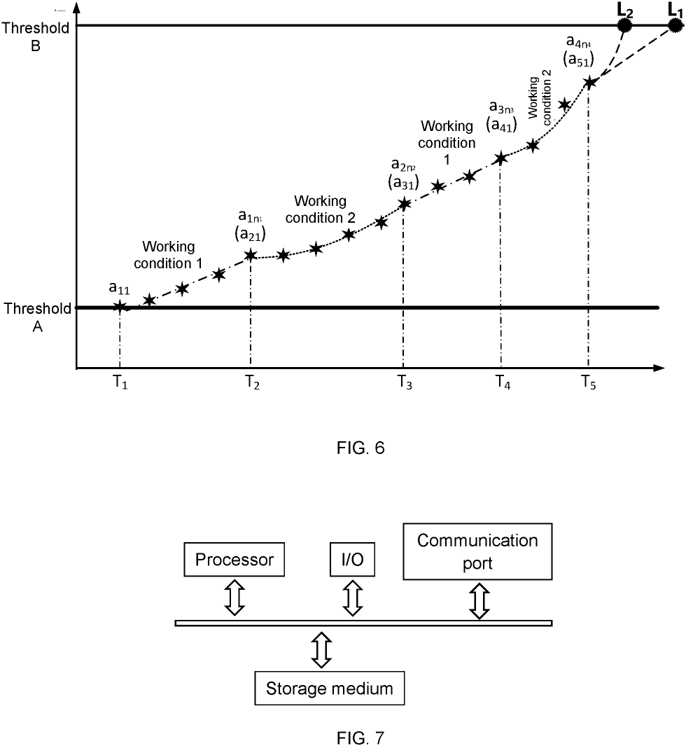

In some exemplary embodiments, a prediction mechanism of second-stage service life prediction is provided. FIG. 6 is a schematic diagram of a prediction mechanism of second-stage service life prediction according to some exemplary embodiments of the present disclosure. As shown in FIG. 6, it is assumed that parameter a is an out-of-tolerance parameter. Considering the degradation process of the parameter a, a degradation threshold and a failure threshold of the parameter a are A and B, respectively. If the degradation threshold A is reached at moment T₁, a second-stage predictive maintenance program is started. It is assumed that the production beat at T₁ is 1 (working condition 1), which is maintained until T₂. Then the production beat becomes 2 (working condition 2), which is maintained until T₃, and further switched to working condition 1. Working condition 1 is maintained until T₄, and then switched to working condition 2, which is maintained until T₅. Taking the time period from T₁ to T₂ as an example, monitoring time points are t₁₁, ...,

$${t}_{1 {n}_{1}}$$

, where n₁ represents a total monitoring count from T₁ to T₂, and corresponding monitoring values are

$${a}_{11} , . . . , {a}_{1 {n}_{1}}$$

. To indicate that the data is under working condition 1, the data is denoted by

$${a}_{11}^{1} , . . . , {a}_{1 {n}_{1}}^{1} .$$

Because T₂ is a working condition switching point,

$${a}_{1 {n}_{1}}^{1} = {a}_{21}^{2} .$$

Therefore, it is obtained that:
working condition 1:
$${a}_{11}^{1} , . . . , {a}_{1 {n}_{1}}^{1} , {a}_{31}^{1} , . . . , {a}_{3 {n}_{3}}^{1} , {a}_{i 1}^{1} , . . . , {a}_{i {n}_{i}}^{1}$$
working condition 2:
$${a}_{21}^{2} , . . . , {a}_{2 {n}_{2}}^{2} , {a}_{41}^{2} , . . . , {a}_{4 {n}_{4}}^{2} , {a}_{j 1}^{2} , . . . , {a}_{j {n}_{j}}^{2}$$

For the degradation data above, the foregoing degradation modeling process may be adopted:

(1) Not all

$$\left[{a}_{11}^{1} , . . . , {a}_{1 {n}_{1}}^{1} , {a}_{31}^{1} , . . . , {a}_{3 {n}_{3}}^{1} , {a}_{i 1}^{1} , . . . , {a}_{i {n}_{i}}^{1}\right]$$

under working condition 1 are taken as one series for fitting and modeling; instead, piecewise fitting is performed, where the segments are

$$\left[{a}_{11}^{1} , . . . , {a}_{1 {n}_{1}}^{1}\right] , \left[{a}_{31}^{1} , . . . , {a}_{3 {n}_{3}}^{1}\right] ,$$

and

$$\left[{a}_{i 1}^{1} , . . . , {a}_{i {n}_{i}}^{1}\right] ;$$

similarly,

$$\left[{a}_{21}^{1} , . . {a}_{2 {n}_{2}}^{2} ,\right)$$

$$\left({a}_{41}^{2} , . . . , {a}_{4 {n}_{4}}^{2} , {a}_{j 1}^{2} , . . . , {a}_{j {n}_{j}}^{2}\right]$$

underworking condition 2 are segmented into

$$\left[{a}_{21}^{2} , . . . , {a}_{2 {n}_{2}}^{2}\right] , \left[\right)$$

$$\left({a}_{41}^{2} , . . . , {a}_{4 {n}_{4}}^{2}\right] ,$$

and

$$\left[{a}_{j}^{2} , … {a}_{j {n}_{j}}^{2}\right] .$$

(2) A modeling method based on degradation amounts may be selected, e.g., time series, stochastic process, or neural network. For example, as a deformation of the stochastic process, the following Wiener process is selected:

$${a}_{i k + 1}^{1} - {a}_{i k}^{1} = {λ}^{1} \left({t}_{i k + 1} - {t}_{i k}\right) + {δ}^{1} B \left({t}_{i k + 1} - {t}_{i k}\right) ,$$

where k=1, ..., nᵢ-1, and B denotes Brownian motion N(0,1²)

For the segments

$$\left[{a}_{11}^{1} , … {a}_{1 {n}_{1}}^{1}\right] , \left[{a}_{31}^{1} , … {a}_{3 {n}_{3}}^{1}\right] , \text{and} \left[{a}_{i 1}^{1} , … {a}_{i {n}_{i}}^{1}\right]$$

under working condition 1,

$${a}_{i k + 1}^{1} - {a}_{i k}^{1}$$

in the segment represents a degradation amount (for example,

$${a}_{1 {n}_{1}}^{1}$$

and

$${a}_{3 1}^{1}$$

are irrelevant, and thus the degradation amount cannot be constructed between segments). Parameter estimation of λ¹ and δ¹ in the foregoing equation is carried out based on a degradation amount expectation maximum (EM) algorithm, where λ¹ and δ¹ denote a degradation rate and degradation uncertainty corresponding to working condition 1.

(3) After the modeling method is selected, fitting is performed on the segments of working condition 1 and the segments of working condition 2 separately. For example, a Wiener process is selected to obtain λ¹ and δ¹ corresponding to working condition 1, and λ² and δ² corresponding to working condition 2; if other models are selected, parameter estimations of other models may be obtained.

(4) Average fitting errors of different modeling methods or models in all the “segments” are calculated, and a model with a smallest average fitting error is selected as a best model. Prediction is performed at T₅ in the figure by using model 1 corresponding to λ¹ and δ¹, which represents a degradation trajectory starting from a₅₁ under working condition 1, to obtain time it takes to reach the threshold B, i.e., service life L1; prediction is performed by using model 2 corresponding to λ² and δ², which represents a degradation trajectory starting from a₅₁ under working condition 2, to obtain service life L2.

(5) Accumulated time lengths of working condition 1 and working condition 2 are calculated according to Tᵢ and Tᵢ₊₁, which are then divided by a total time length, to determine working condition ratios, which are used as weights w1 and w2 of the service lives.

In step S4, a predictive maintenance strategy of the intelligent manufacturing equipment may be determined according to the first-stage remaining service life and the second-stage remaining service life. Specifically, the maintenance strategy in step S4 may include: (1) purchase spare parts according to service life results of the first-stage prediction of different parts of the intelligent equipment; and (2) selecting an optimal production break as a maintenance timing with reference to the service life result of the second-stage prediction in combination with the production planning, maintenance costs, equipment availability, etc.

The predictive maintenance system and method for intelligent manufacturing equipment according to some exemplary embodiments of the present disclosure provide a predictive maintenance solution to intelligent manufacturing equipment such as industrial robots, to provide technical support for equipment proactive operation and maintenance in an intelligent manufacturing environment, reduce unexpected shutdown for the user, reduce downtime for the user, reduce the costs of operation and maintenance for the user/manufacturer, and improve the efficiency of operation and maintenance.

Some exemplary embodiments of the present disclosure are illustrated above. Undoubtedly, those of ordinary skill in the art may modify the described embodiments in different ways without departing from the spirit and scope of the present disclosure. Therefore, the accompanying drawings and description above are illustrative, and shall not be construed as a limitation to the scope of the present disclosure.

1. A predictive maintenance system for intelligent manufacturing equipment, comprising:
at least one storage medium storing at least one set of instructions for the predictive maintenance;
at least one processor in communication with the at least one storage medium, wherein during operation, the at least one processor executes the set of instructions to:
obtain control parameters of the intelligent manufacturing equipment,
conduct a first-stage predictive maintenance to determine a long-term first-stage remaining service life of the intelligent manufacturing equipment based on a statistical model or an empirical model according to the control parameters, conduct a second-stage predictive maintenance to:
receive state parameters and spot check parameters of the intelligent manufacturing equipment, wherein the spot check parameters are state parameters of the intelligent manufacturing equipment in at least one specific working condition,
set a degradation threshold and a failure threshold for each state parameter and each spot check parameter, and
construct at least one time series starting from the degradation threshold for each state parameter or spot check parameter exceeding the degradation threshold, perform degradation modeling for the at least one time series, and predict a short-term second-stage remaining service life of the intelligent manufacturing equipment; and
determine a predictive maintenance strategy of the intelligent manufacturing equipment according to the first-stage remaining service life and the second-stage remaining service life.

2. The predictive maintenance system according to claim 1, wherein the at least one processor further executes the set of instructions to:
set different acquisition cycles and communication cycles corresponding to a normal state and an abnormal state for different state parameters and spot check parameters;
the normal state is a state in which the degradation threshold is not exceeded, and the abnormal state is a state in which the degradation threshold is exceeded; and
the communication module is configured to receive, from the intelligent manufacturing equipment based on the communication cycles, the state parameters and the spot check parameters obtained based on the acquisition cycles.

3. The predictive maintenance system according to claim 1, wherein in the first-stage predictive maintenance, the at least one processor executes the set of instructions to:
determine equivalent loads under different working conditions according to control parameters obtained within a time interval between a current moment and a last trigger moment;
determine a degree of loss at the current moment according to the equivalent loads; and
determine the first-stage remaining service life according to the degree of loss at the current moment.

4. The predictive maintenance system according to claim 3, wherein in the first-stage predictive maintenance, the at least one processor executes the set of instructions to:
apply multiple acting forces to a component of the intelligent manufacturing equipment;
determine degrees of loss under the multiple acting forces;
superimpose the degrees of loss under the multiple acting forces linearly to obtain a superimposed degree of loss;
determine a remaining service life of the component according to the superimposed degree of loss;
determine remaining service lives of all components of the intelligent manufacturing equipment; and
determine a shortest remaining service life among the remaining service lives of all components of the intelligent manufacturing equipment as the first-stage remaining service life of the intelligent manufacturing equipment.

5. The predictive maintenance system according to claim 4, wherein
the multiple acting forces include at least one torque and at least one radial force;
in the first-stage predictive maintenance, the at least one processor executes the set of instructions to:
determine a torque service life of a mechanical component under the at least one torque;
determine a radial force service life of the mechanical component under the at least one radial force;
superimpose a degree of loss under the at least one torque and a degree of loss under the at least one radial force linearly to obtain a superimposed degree of loss, wherein the degree of loss under the at least one torque is equal to a ratio of a time length between the current trigger moment and the last trigger moment to a torque service life corresponding to a working condition within the time length, and the degree of loss under the at least one radial force is equal to a ratio of a time length between the current trigger moment and the last trigger moment to a radial force service life corresponding to a working condition within the time length; and
determine a remaining service life of the mechanical component according to the superimposed degree of loss.

6. The predictive maintenance system according to claim 5, wherein
the multiple acting forces include multiple torques and multiple radial forces;
degrees of loss of the multiple torques or the multiple radial forces are superimposed linearly to obtain a superimposed degree of loss; and
the first-stage remaining service life is determined according to the superimposed degree of loss.

7. The predictive maintenance system according to claim 1, wherein in the second-stage predictive maintenance, the at least one processor executes the set of instructions to:
perform degradation modeling for the at least one time series to predict remaining service lives under different working conditions; and
collect statistical data of the remaining service lives based on a normal distribution, so as to obtain a remaining service life distribution as the second-stage remaining service life.

8. The predictive maintenance system according to claim 7, in the second-stage predictive maintenance, to perform the degradation modeling for the at least one time series, the at least one processor executes the set of instructions to:
perform piecewise fitting on the at least one time series under the different working conditions;
select a Wiener process to obtain degradation rates and degradation uncertainty under the different working conditions; and
predict remaining service lives under the different working conditions based on models corresponding to the degradation rates and the degradation uncertainty under the different working conditions.

9. The predictive maintenance system according to claim 1, wherein the first-stage predictive maintenance is triggered by at least one of the following modes:
triggering manually by a user of the intelligent manufacturing equipment;
triggering according to a preset work cycle; or
triggering following a working condition change.

10. A predictive maintenance method for intelligent manufacturing equipment, comprising:
obtaining control parameters and state parameters of the intelligent manufacturing equipment in real time, and obtaining spot check parameters of the intelligent manufacturing equipment periodically;
triggering first-stage predictive maintenance to determine a long-term first-stage remaining service life of the intelligent manufacturing equipment based on a statistical model or an empirical model according to the control parameters;
stopping the first-stage predictive maintenance and triggering second-stage predictive maintenance when any one of the state parameters and the spot check parameters exceeds a preset degradation threshold;
in the second-stage predictive maintenance, constructing at least one time series starting from the degradation threshold for each state parameter or spot check parameter exceeding the degradation threshold, performing degradation modeling for the at least one time series, and predicting a short-term second-stage remaining service life of the intelligent manufacturing equipment, wherein the spot check parameters are state parameters of the intelligent manufacturing equipment in at least one specific working condition; and
determining a predictive maintenance strategy of the intelligent manufacturing equipment according to the first-stage remaining service life and the second-stage remaining service life.

11. The predictive maintenance method according to claim 10, wherein the triggering of the first-stage predictive maintenance includes at least one of:
triggering manually by a user of the intelligent manufacturing equipment;
triggering according to a preset work cycle; or
triggering following a working condition change.

12. The predictive maintenance method according to claim 11, wherein in the first-stage predictive maintenance,
equivalent loads under different working conditions are determined according to control parameters obtained within a time interval between a current moment and a last trigger moment;
a degree of loss at the current moment is determined according to the equivalent loads; and
the first-stage remaining service life is determined according to the degree of loss at the current moment.

13. The predictive maintenance method according to claim 10, wherein in the first-stage predictive maintenance,
equivalent loads under different working conditions are determined according to control parameters obtained within a time interval between a current moment and a last trigger moment;
a degree of loss at the current moment is determined according to the equivalent loads; and
the first-stage remaining service life is determined according to the degree of loss at the current moment.

14. The predictive maintenance method according to claim 13, wherein in the first-stage predictive maintenance,
multiple acting forces are applied to a component of the intelligent manufacturing equipment, degrees of loss under the multiple acting forces are determined;
the degrees of loss under the multiple acting forces are superimposed linearly to obtain a superimposed degree of loss;
a remaining service life of the component is determined according to the superimposed degree of loss;
remaining service lives of all components of the intelligent manufacturing equipment are determined; and
a shortest remaining service life among the remaining service lives of all components of the intelligent manufacturing equipment is determined as the first-stage remaining service life of the intelligent manufacturing equipment.

15. The predictive maintenance method according to claim 14, wherein
the multiple acting forces include at least one torque and at least one radial force;
in the first-stage predictive maintenance, a torque service life of a mechanical component under the at least one torque is determined;
a radial force service life of the mechanical component under the at least one radial force is;
a degree of loss under the at least one torque and a degree of loss under the at least one radial force are superimposed linearly to obtain a superimposed degree of loss, wherein the degree of loss under the at least one torque is equal to a ratio of a time length between the current trigger moment and the last trigger moment to a torque service life corresponding to a working condition within the time length, and the degree of loss under the at least one radial force is equal to a ratio of a time length between the current trigger moment and the last trigger moment to a radial force service life corresponding to a working condition within the time length; and
a remaining service life of the mechanical component is determined according to the superimposed degree of loss.

16. The predictive maintenance method according to claim 15, wherein
the multiple acting forces include multiple torques and multiple radial forces;
degrees of loss of the multiple torques or the multiple radial forces are superimposed linearly to obtain a superimposed degree of loss; and
the first-stage remaining service life is determined according to the superimposed degree of loss.

17. The predictive maintenance method according to claim 10, wherein in the second-stage predictive maintenance,
degradation modeling is performed for the at least one time series to predict remaining service lives under different working conditions; and
statistical data of the remaining service lives are collected based on a normal distribution, so as to obtain a remaining service life distribution as the second-stage remaining service life.

18. The predictive maintenance method according to claim 17, wherein in the second-stage predictive maintenance,
the performing of the degradation modeling for the at least one time series includes:
performing piecewise fitting on the at least one time series under the different working conditions;
selecting a Wiener process to obtain degradation rates and degradation uncertainty under the different working conditions; and
predicting remaining service lives under the different working conditions based on models corresponding to the degradation rates and the degradation uncertainty under the different working conditions.

19. The predictive maintenance method according to claim 13, wherein in the second-stage predictive maintenance,
degradation modeling is performed for the at least one time series to predict remaining service lives under different working conditions; and
statistical data of the remaining service lives are collected based on a normal distribution, so as to obtain a remaining service life distribution as the second-stage remaining service life.

20. The predictive maintenance method according to claim 19, wherein in the second-stage predictive maintenance,
the performing of the degradation modeling for the at least one time series includes:
performing piecewise fitting on the at least one time series under the different working conditions;
selecting a Wiener process to obtain degradation rates and degradation uncertainty under the different working conditions; and
predicting remaining service lives under the different working conditions based on models corresponding to the degradation rates and the degradation uncertainty under the different working conditions.
